(19) United States
(12) Patent Application Publication
(10) Pub. No.: US 2024/0229433 A1
(43) Pub. Date: Jul. 11, 2024

(54) AUTOMATED FLUID DISPENSING DEVICE

(71) Applicant: ROTEX AUTOMATION LIMITED, Vadodara (IN)

(72) Inventor: Nirav SHAH, Vadodara (IN)

(21) Appl. No.: 18/559,170

(22) PCT Filed: May 4, 2022
(86) PCT No.: PCT/IB2022/054113

§ 371 Date: Nov. 6, 2023

(30) Foreign Application Priority Data
May 4, 2021 (IN) 202121020384

(51) Int. Cl. E03C 1/05; A47K 5/12

(52) U.S. Cl. CPC E03C 1/057; A47K 5/1217

(57) ABSTRACT

An automated fluid dispensing device is disclosed. The device includes one or more sensors configured to sense presence of an object within a predefined distance, and a solenoid valve to control flow of fluid through a nozzle. Based on data packets received from the sensors, the object within the predefined distance is detected; and upon detection, the solenoid valve is actuated to control flow of fluid. The solenoid valve is actuated by moving the plunger in an opened position when the object is detected within the predefined distance, and wherein, to move the plunger, the control circuitry being configured to allow flow of current in the electrical coil to generate magnetic flux, and wherein the generated magnetic flux allows the plunger to move in the opened position to create the flow path for dispensing the liquid from a fluid source.

### TECHNICAL FIELD

The present disclosure relates to the field of fluid dispensing devices. More particularly, the present disclosure relates to the fluid dispensing device for dispensing the liquid in a controlled and automated manner without contacting the fluid dispensing device.

### BACKGROUND

The background description includes information that may be useful in understanding the present invention. It is not an admission that any of the information provided herein is prior art or relevant to the presently claimed invention, or that any publication specifically or implicitly referenced is prior art.

In recent times, the rise in pathogenic exposure has been caused by extremely fatal viruses such as coronavirus (COVID) or severe acute respiratory syndrome coronavirus 2 (SARS-COV-2), for which a person may require wearing a mask to avoid inhaling pathogens. However, body parts such as hands, which are crucial carrier points of such viruses, may also need to be washed effectively by fluid dispensing units such as water taps. One such implementation of the fluid dispensing units may involve taps that allow the flow of water, for usage such as, for example, washing hands. The taps are usually installed in several private and public places, and are usually manually operated. Such a manually operated tap may be useful in normal scenarios, however, during such a situation of the pandemic, a user may need to avoid contacting any surface to minimize pathogenic exposure. Therefore, the manually operated conventional tap may not only be inconvenient in such situations but also pointless as the user may contaminate hands by using such taps thereby defeating the purpose of washing hands.

As it may be completely pointless to use manually operated taps, a need for automated operated taps can be seen. Although the concept of automated fluid dispensers or taps may be known, however, the conventional automated taps may involve several disadvantages such as improper dispensing, improper regulation of fluid dispensing, lack of appropriate electrical units and lack of cost-effective as well as practical implementation to be able to set up such fluid dispensing devices in wide usage such as, for example, at both private and public places.

There is therefore a need to provide a device for automatically dispensing a fluid that overcomes the aforementioned limitation and provides an effective, contactless, automated and quick dispensing of fluid without the need to touch the dispenser.

### OBJECTS OF THE INVENTION

A general object of the present disclosure is to provide an improved fluid dispensing device that provides an effective, contactless, automated and quick dispensing mechanism.

An object of the present disclosure is to provide an improved fluid dispensing device that allows proper regulation of dispensing of the fluid.

An object of the present disclosure is to provide an improved fluid dispensing device that includes a solenoid valve being operated on the principle of magnetic flux.

An object of the present disclosure is to provide a simple and cost-effective fluid dispensing device.

### SUMMARY

The present disclosure relates to field of fluid dispensing devices. More particularly, the present disclosure relates to the fluid dispensing device for dispensing the liquid in a controlled and automated manner without contacting the fluid dispensing device.

In an aspect, the present disclosure provides an automated fluid dispensing device. The device includes one or more sensors configured to sense presence of an object within a predefined distance; a solenoid valve comprising an electrical coil and a plunger, the solenoid valve configured to control flow of fluid through a nozzle; and a control circuitry. The control circuitry includes one or more processors coupled to a memory, the memory storing instructions, which, when executed by the one or more processors, cause the control circuitry to: receive one or more data packets from the one or more sensors, detect the object in the predefined distance based on the received one or more data packets; and upon the detection of the object within the predefined distance, actuate the solenoid valve to control flow of fluid, wherein the solenoid valve is actuated by moving the plunger in an opened position when the object is detected within the predefined distance, and wherein, to move the plunger, the control circuitry is configured to allow flow of current in the electrical coil to generate magnetic flux, and wherein the generated magnetic flux allows the plunger to move in the opened position to create the flow path for dispensing the liquid from a fluid source.

In an embodiment, the one or more sensors comprise a proximity sensor, wherein the proximity sensor includes any or a combination of an infrared sensor, a camera sensor, a thermopile sensor, a thermocouple.

In an embodiment, the device includes a power source configured to provide electrical power to the control circuitry.

In an embodiment, the control circuitry comprising a solenoid driver configured to actuate the solenoid valve, wherein the solenoid driver comprises a metal-oxide-semiconductor field-effect transistor (MOSFET).

In an embodiment, the device includes a mounting clamp for clamping the automated fluid dispensing device to one or more locations in proximity to the fluid source.

In an embodiment, the device includes a USB connector to provide electrical power to external electronic devices.

Various objects, features, aspects and advantages of the inventive subject matter will become more apparent from the following detailed description of preferred embodiments, along with the accompanying drawing figures in which like numerals represent like components

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first t reference label irrespective of the second reference label.

FIG. 1A illustrates a perspective view of an exemplary representation of the proposed fluid dispensing device, in accordance with an embodiment of the present disclosure.

FIG. 1B illustrates an exemplary representation of the configuration of a proximity sensor of the proposed dispensing device, in accordance with an embodiment of the present disclosure.

FIG. 2 illustrates an exemplary representation of the configuration of an actuator of the proposed dispensing device, in accordance with an embodiment of the present disclosure.

FIGS. 3A-3D illustrate exemplary views of the proposed fluid dispensing device, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program (s) coded in accordance with various methods described herein, and the method steps of the invention could be accomplished by modules, routines, subroutines, or subparts of a computer program product.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Various objects, features, aspects and advantages of the present disclosure will become more apparent from the following detailed description of preferred embodiments, along with the accompanying drawing figures in which like numerals represent like features.

Embodiments herein relate to the fluid dispensing device. More particularly, the present disclosure relates to a device for dispensing the fluid in an automated manner. The device includes one or more sensors that sense presence of an object within a predefined distance. When the object is detected within a predefined distance, the actuator is actuated for dispensing the fluid according to the requirement. As an example and without limitation, the device may enable flow or dispensing of the fluid when a human hand approaches an outlet or at a dispensing point of the device, as the sensor may sense the presence and give a signal in form of one or more data packets to the controlling component to operate the actuator to allow the flow of the fluid.

The following sections describe an exemplary implementation of the proposed fluid dispensing device of the embodiment of the disclosure. This description is solely for the demonstration of the function and use of the proposed device. Those skilled in the art will appreciate that there can be other potential implementations of the proposed device and the present illustration may not be construed as a limitation to the use of the proposed device in any of the other potential implementations.

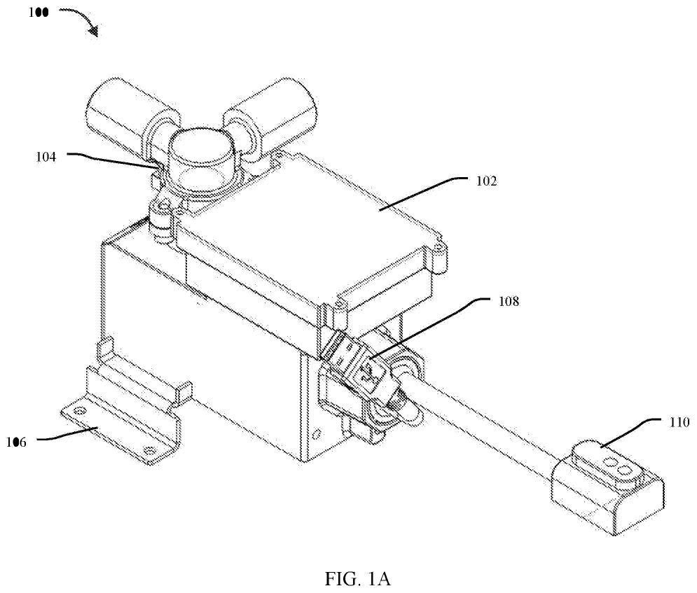

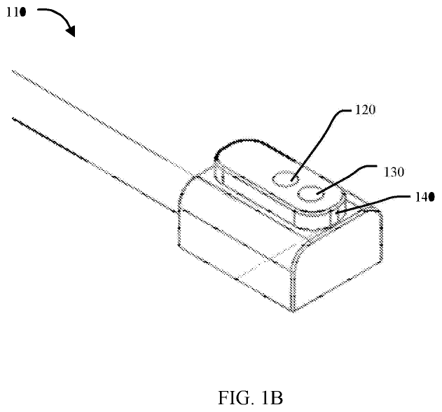

As illustrated in FIG. 1A, the fluid dispensing device 100 may include one or more sensors configured to sense presence of an object such as a human hand within a predefined distance. In an exemplary embodiment, the sensors may be able to sense, without limitation, within a distance of 1 cm to 400 cm. In a preferred embodiment, the predefined distance may be 350 mm. The one or more sensors may include a proximity sensor 110 allowing detection of the object, which acts as a trigger for dispensing the fluid. The proximity sensor 110 is operated based on infrared sensing techniques to assess the proximity of any object. In an embodiment, upon sensing the presence of an object, the proximity sensor 110 may give a signal to the control circuitry to operate the solenoid valve and allow the flow of fluid such as water. In an exemplary embodiment, the proximity sensor may be any or a combination of an infrared sensor, a camera sensor, a thermopile sensor, a thermocouple and any such proximity sensing devices.

In an embodiment, the device 100 may include an actuator 104 configured to control the flow of the fluid from the fluid source. In an embodiment, the actuator may include, but not limited to, at least one of mechanical actuators, an electrical actuator, a pneumatic actuator, an electromechanical actuator and a hydraulic actuator. The actuator 104 may include a solenoid valve 104 that may be configured to open and close the path to flow the fluid, thereby controlling the flow of the fluid.

In an embodiment, the device 100 may include the control circuitry including one or more processors coupled to a memory. The memory stores instructions, which, when executed by the one or more processors, cause the control circuitry to perform one or more control actions. In an exemplary embodiment, among other capabilities, the control circuitry is configured to fetch and execute computer-readable instructions stored in a memory of the disclosed touchless. The memory may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory may include modules, routines, programs, objects, components, data structures, etc., of encryption. In an embodiment, the control circuitry may be operatively coupled with the one or more sensors and the actuator. The control circuitry may receive the one or more data packets from the one or more sensors, and detect the object in the predefined distance based on the received one or more data packets. Upon detection of the object within the predefined distance, the control circuitry may actuate the solenoid valve to control the flow of fluid. The control circuitry comprises a solenoid driver configured to actuate the solenoid valve, where the solenoid driver comprises a metal-oxide-semiconductor field-effect transistor (MOSFET).

In an exemplary embodiment, the control circuitry may include at least one of a microprocessor, a microcomputer, microcontroller, a digital signal processor, a central processing unit, state machines, logic circuitries, and/or any devices that can receive signals from the sensors based on operational instructions and enable the actuator to perform the actuation. In an exemplary embodiment, among other capabilities, the processing unit is configured to fetch and execute computer-readable instructions stored in a memory of the disclosed touchless. The memory may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory may include modules, routines, programs, objects, components, data structures, etc., of encryption.

In an embodiment, the control circuitry may be connected to one or more user devices or any computing device by using a wired or wireless communication interface. The wireless communication interface may include, but not limited to, Bluetooth®, radio frequency (RF), and near field communication (NFC). In an exemplary embodiment, the fluid dispensing device may communicate with a user device such as a mobile phone using a wireless communication interface such as Bluetooth®. Such communication may enable to pre-set one or more parameters related to fluid dispensing, such as, for example, the amount of water to be released and other such settings, where the parameters/settings may be adjusted by using the user device or the computing device.

In an exemplary embodiment, the solenoid valve may include an electrical coil and a plunger. The solenoid valve is operated based on the magnetic principle. The solenoid valve may be actuated by moving the plunger in an opened position when the object is detected within the predefined distance. In order to move the plunger, the control circuitry is configured to allow flow of current in the electrical coil to generate magnetic flux. As a result of the generation of magnetic flux, the plunger moves in the opened position to create the flow path for dispensing the liquid from a fluid source. In an embodiment, there may be more than one pathway or flow path to allow the flow of fluid from the fluid source. In an embodiment, when the object is removed in the closed proximity of the device i.e. the object is not within the predefined distance from the sensors, the control circuitry may be configured to actuate the solenoid valve to close the path as not to flow of fluid through the nozzle. In particular, the current in the electrical coil is reduced, thus the effect of the magnetic flux is reduced. As a result, the plunger may move back to its closed position. In an example, the plunger may be configured with an elastic member to allow the plunger to move back to its closed position when the effect of the magnetic flux is removed or reduced.

In an embodiment, the fluid dispensing device may be coupled to a fluid source by one or more known techniques. In an exemplary embodiment, the fluid can be water or any such fluids used for washing or cleaning. Out of several other possible embodiments, one particular embodiment may include the use of the fluid dispensing device in situations such as pandemic which may require contactless access to fluid, to wash or clean hands or other parts whenever desired without the need to touch the fluid dispensing device. In another exemplary embodiment, the fluid dispensing device may also be used for dispensing any fluid including, but not limited to, sanitizing fluid, disinfecting liquid, soap solution, cleansing solution and handwashing fluid. The fluid dispensing device may enable automated dispensing of one or more types of fluids without the need to manually touch any part of the device. In an exemplary embodiment, the fluid dispensing device may enable dispensing of two or more types of fluids, such as, for example, a water source and a soap solution, from separate dispensing points. In such cases, there may be multiple nozzles configured with corresponding pathways to allow different types of fluids. Various other such embodiments are within the scope of the present disclosure without departing from the basic scope thereof.

In an embodiment, the fluid dispensing device may include one or more dispensing points in form of one or more fluid dispensing outlets or nozzles, such that when actuated by the actuator, the fluid may be dispensed from the fluid dispensing nozzle. The fluid dispensing nozzle may be positioned such that an effective dispensing may be done, without touching the device, as per the requirements of the user. Each fluid dispensing nozzle may have one or more openings for releasing one or more types of the fluid in a specific manner as desired by a user. In an exemplary embodiment, the nozzle may include a plurality of pores that may have varying sizes and/or shapes. The shape and configuration of the fluid dispensing points or nozzle, as well as the openings of the nozzle, may not be restricted to the stated embodiments and various other shapes/sizes/configurations may be implemented.

In an embodiment, the device 100 may include a power source configured within a battery compartment 102 and a Universal Serial Bus (USB) connector 108. The power source may provide electrical power to the control circuitry. The battery compartment 102 may be used to house one or power sources such as batteries. The USB connector 108 may be used to establish a connection for charging one or more electronic devices and the batteries, such that in events of a power cut of the grid, the device 100 may act as a backup power source. In an embodiment, a male USB connection may be used for enabling the end-user to power the device using, for example, a 5V adapter, thus ensuring the safety of users.

In an embodiment, the power source may be configured to power one or more electrical components of the device. The power source may include at least one of a battery, a rechargeable battery, a fixed battery source, a battery operating on renewable power, a direct electrical power source connected via an adaptor, AC supply provided by an adaptor, AC supply provided by an adaptor with a male USB connector and other such power sources. Various other such power sources may be used. In an exemplary embodiment, the fluid dispensing device may include an inbuilt power source, with an option to recharge the fluid dispensing device by plugging to an external source or an electrical point. In an embodiment, the actuator may include a solenoid driver including a metal-oxide-semiconductor field-effect transistor (MOSFET) which may be employed in an electronic circuit, wherein the driver may use two power sources as power such as, for example, one from the battery compartment and the other from USB adapter which may be powered by supply mains. In an exemplary embodiment, the present disclosure may disclose an automatic tap, configured with a solenoid-operated valve, a proximity sensor, a battery, and a USB-based power delivery mechanism. In an embodiment, the solenoid coil/winding and electronic parts of the control unit may be coherently assembled and epoxy-potted to form an integrated assembly. The proximity sensor may sense the presence of a body near/around the tap and signal the solenoid valve for its actuation such that at any moment, a person reaches out to the tap, a fluid such as water, may start flowing out of the tap.

In another embodiment, the device may also include a mounting clamp 106 for clamping the device to one or more locations near the fluid source. The mounting clamp 106 may facilitate the mounting of the solenoid valve on a wall or surface, where the faucet needs to be installed.

FIG. 1B illustrates an exemplary configuration of a proximity sensor 110 of the dispensing device, in accordance with an embodiment of the present disclosure. As illustrated in FIG. 1B, the proximity sensor 110 may include a sensor eye 140 for sensing the presence of an object. The proximity sensor 110 may also include a receiver 120 for receiving or generating a sensed signal corresponding to the sensed attributes and a transmitter/emitter 130 for transmitting the signal corresponding to the sensed attributes. Upon sensing an object, the sensor 110 may activate in presence of the object such that a driver circuit present in the device may sense the change in the value of current drawn by the circuit and a microcontroller may trigger the solenoid valve.

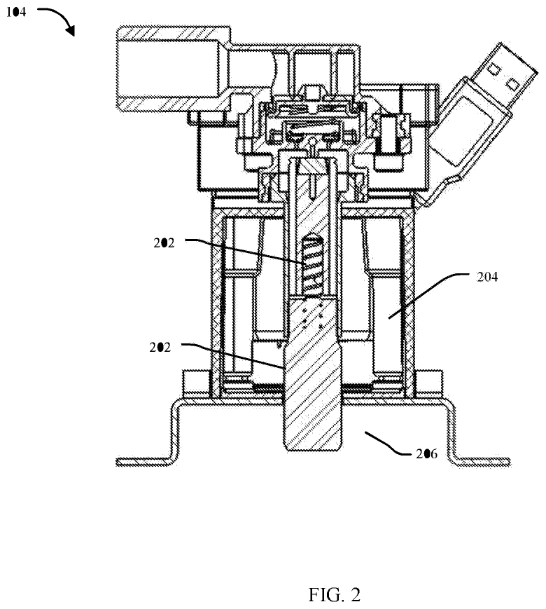

FIG. 2 illustrates an exemplary representation of the configuration of an actuator of the proposed dispensing device, in accordance with an embodiment of the present disclosure. The actuator 104 may include a solenoid valve comprising a static core 206, a coil 204, and a plunger 202. In an embodiment, upon the detection of the object within a predefined distance, the control circuitry may generate an electrical signal to be applied to the actuator to actuate. Accordingly, a current may flow through coil 204 which in turn may generate magnetic flux around the core. The magnetic flux may allow the plunger to move in the opened position. In an example, the magnetic flux may generate a rotary force on the plunger 202 which allows the plunger to open a sealed flow path through which the fluid can travel to the nozzle and then dispense. In an embodiment, when the plunger may be at the closed position, more power may be required to move the plunger 202 through the air gap and once the air gap is closed, the power required may be less. This inherent capability may be exploited by using the control circuitry.

In an embodiment, the control circuitry may perform an optimized dispensing of the fluid. The control circuitry may be configured to actuate the actuator to dispense the fluid within a predetermined amount. In an embodiment, to dispense the fluid within the predetermined amount, the actuator or the plunger may be moved in a partially opened position. In an embodiment, to move the plunger in the partially opened position, the current flowing in the coil would be less than the current flowing in the coil corresponding to a fully opened position.

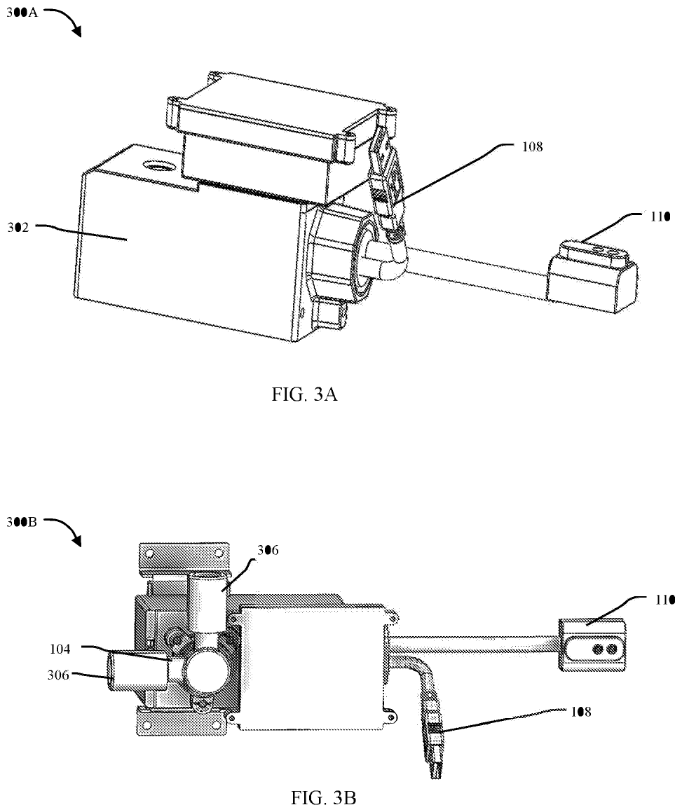

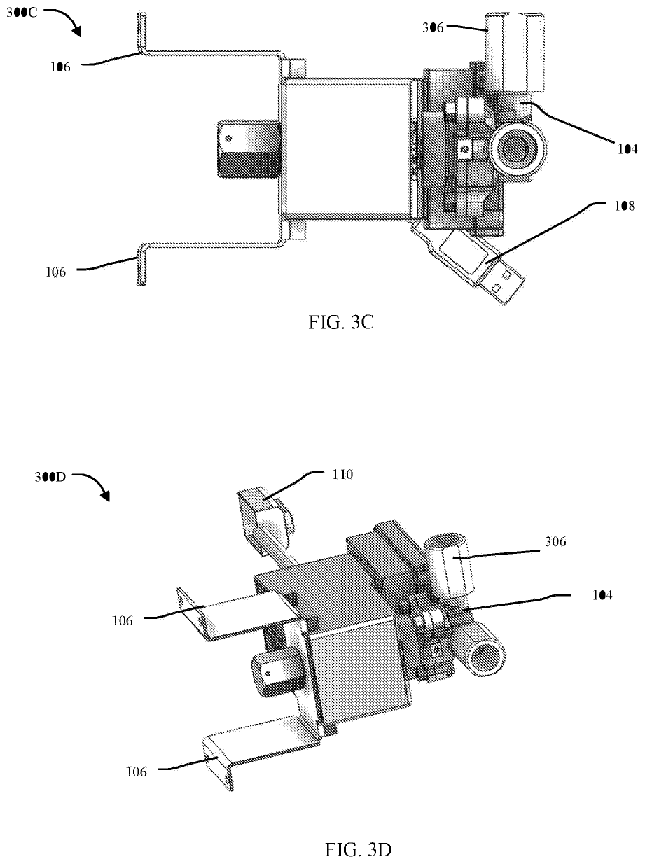

FIGS. 3A-3D illustrate exemplary views of the proposed fluid dispensing device, in accordance with an embodiment of the present disclosure. As illustrated in FIGS. 3A-3D, the device may include a housing 302 that may be in form of an enclosure such as but not limited to a box, for accommodating coil winding and control circuitry inside the housing at one place. This feature facilitates reliable waterproofing compared to all conventional products in which coil winding and control circuitry are usually separated. Further, another advantage of the device includes the possibility of servicing the solenoid even if the solenoid wires are potted along with electronics. In an embodiment, the servicing may be done by a user, wherein the user may be able to have side access to the solenoid valve 104 through one or more nuts 306 such that the user may be able to remove the nut 306 without de-mounting the solenoid valve 104 from the bracket for maintenance of solenoid valve. This mechanism avoids the opening up of the whole assembly even when the user needs to open the solenoid valve. Thus, the device of the present disclosure enables removing the solenoid without opening up the valve, thereby making servicing easy. In an embodiment, the user may be able to perform the servicing of the solenoid without the need to stop the flow of the water provided flexible hose connections are facilitated to the inlet and outlet ports of the valve.

In an embodiment, the housing 302 may have an externally provided attachment member or mounting clamp to fasten the fluid dispensing device to a surface such as, for example, a wall, a pillar, a faucet or any such points where the fluid dispensing device may need to be installed. The attachment member may include any known component and several types of attachments used to fasten the fluid dispensing device to the desired surface.

In an embodiment, the fluid dispensing device may include a housing that may partially or completely cover one or more components of the fluid dispensing device. The housing may accommodate one or more components such as one or more sensors, an actuator/controller and a power source, that may be disposed of in the housing. In an embodiment, the housing of the fluid dispensing device may include a compartment for accommodating one or more electrical components of the dispenser device. Various other embodiments are possible and the compartment may be present at any position inside the housing.

In an embodiment, the USB connector 108 as described above may be a mobile phone charger with specifications of 230V to 5V DC conversion that may be provided outside housing 302 or solenoid enclosure with a long cable so that it may be kept away from any possible water leakage around solenoid valve 104 to avoid short circuit. Thus, the device also provides enhanced safety over conventional systems.

In an embodiment, there may be another fluid source to dispense another fluid upon detection of the object. In an example, there may be two nozzles, one may be configured to release the first fluid, and the second may be configured to release the second fluid, upon detection of the object. Alternatively or additionally, there may be two detection mechanisms, each acts as a trigger to dispense of one fluid.

In an exemplary embodiment, the fluid dispensing device of the present disclosure may be useful in several situations. As an example, the fluid dispensing device may be an automated tap for dispensing water on hands in a contactless and effective manner, such that a user may not be required to touch contaminated surfaces on the device/tap to avoid or reduce the exposure/risk of infection to extremely fatal viruses such as coronavirus (COVID) or severe acute respiratory syndrome coronavirus 2 (SARS-COV-2). In such a case, such automated taps can be effectively installed at workplaces such as hospitals, airports, restaurants, social places and the like, wherein the automated taps may dispense fluid such as water and/or other fluids on the hands of the user without the need to touch the tap. The present disclosure discloses a fluid dispensing device that includes an actuator such as solenoid and electronic control unit in the same enclosure, thereby offering the advantage that in case of leakage in the valve, the dispensed fluid may not reach the electrical circuit, thus ensuring the safety of usage. The present device also does not need huge box-like other, and also the whole configuration or components can be assembled together and epoxy potted for enhanced insulation. The components such as, for example, sensor, electronic unit and solenoid valve or actuator can also be individually serviced and hence there is no need to replace the complete unit. The present system also caters to customers who may require an adaptor for AC supply, for example, with a male USB connector or detachable sensor cable connector for easy removal. The system may also include a fixed battery source for effective usage. This makes the entire system very effective and user-friendly.

It should be apparent to those skilled in the art that many more modifications besides those already described are possible without departing from the inventive concepts herein. The inventive patient matter, therefore, is not to be restricted except in the spirit of the appended claims. Moreover, in interpreting both the specification and the claims, all terms should be interpreted in the broadest possible manner consistent with the context. In particular, the terms “includes” and “including” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides an improved fluid dispensing device that provides an effective, contactless, automated and quick dispensing mechanism.

The present disclosure provides an improved fluid dispensing device that allows proper regulation of dispensing of the fluid.

The present disclosure provides an improved fluid dispensing device that includes a solenoid valve being operated on the principle of magnetic flux.

The present disclosure provides the device that includes a housing 302 for accommodating coil winding and control circuitry inside the housing in one place.

The present disclosure provides a simple and cost-effective fluid dispensing device.

We claim:

1. An automated fluid dispensing device comprising:
one or more sensors configured to sense presence of an object within a predefined distance;
a solenoid valve comprising an electrical coil and a plunger, the solenoid valve configured to control flow of fluid through a nozzle;
a control circuitry comprising one or more processors coupled to a memory, the memory storing instructions, which, when executed by the one or more processors, cause the control circuitry to:
receive one or more data packets from the one or more sensors;
detect the object within the predefined distance based on the received one or more data packets; and
upon the detection of the object within the predefined distance, actuate the solenoid valve to control flow of fluid, wherein the solenoid valve is actuated by moving the plunger in an opened position when the object is detected within the predefined distance, and wherein, to move the plunger, the control circuitry being configured to allow flow of current in the electrical coil to generate magnetic flux, and wherein the generated magnetic flux allows the plunger to move in the opened position to create the flow path for dispensing the liquid from a fluid source.

2. The automated fluid dispensing device as claimed in claim 1, wherein the one or more sensors comprise a proximity sensor, wherein the proximity sensor includes any or a combination of an infrared sensor, a camera sensor, a thermopile sensor, a thermocouple.

3. The automated fluid dispensing device as claimed in claim 1, comprising a power source configured to provide electrical power to the control circuitry.

4. The automated fluid dispensing device as claimed in claim 1, wherein the control circuitry comprising a solenoid driver configured to actuate the solenoid valve, wherein the solenoid driver comprises a metal-oxide-semiconductor field-effect transistor (MOSFET).

5. The automated fluid dispensing device as claimed in claim 1, comprising a mounting clamp for clamping the automated fluid dispensing device to one or more locations in proximity to the fluid source.

6. The automated fluid dispensing device as claimed in claim 1, comprising a USB connector to provide an electrical power to external electronic devices.
